(19) United States
(12) Patent Application Publication
(10) Pub. No.: US 2015/0183358 A1
(43) Pub. Date: Jul. 2, 2015

(54) HEAVY DUTY TILT BED DELIVERY TRAILER

(71) Applicant: Randall B. Marble, Tremonton, UT (US)

(72) Inventor: Randall B. Marble, Tremonton, UT (US)

(73) Assignee: Green Valley of Utah, LLC, Las Vegas, NV (US)

(21) Appl. No.: 14/081,909

(22) Filed: Nov. 15, 2013

(51) Int. Cl. B60P 1/28; B60D 1/52; B62D 63/06

(52) U.S. Cl. CPC B60P 1/28; B62D 63/062; B60D 1/52

(57) ABSTRACT

As a present invention, a Tilt Bed Trailer with a single axel with standard two wheel assembly on a heavy duty chassis, rearward hitched, heavy duty trailer constructed in a manner to allow for one or two cargo pallets to be unloaded from the trailer without needing a forklift, or comparable secondary device. The bed of a Tilt Bed Trailer can be elevated by means of a manual, hydraulic, or electric jack that allows the cargo to off-load from the tilted bed of the trailer. The novel utility allows the cargo to come in contact with the ground, thus enabling weight and gravity to keep the cargo in place while the trailer exits from beneath the cargo.

### CROSS-REFERENCE TO RELATED APPLICATIONS

None

### FEDERALLY SPONSORED RESEARCH

None

### SEQUENCE LISTING

None

### FIELD OF INVENTION

A present invention and a current embodiment, identified herein as a “Tilt Bed Trailer,” relates generally to a trailer adapted to be hitched to the rearward end of a vehicle and more particularly to a trailer including an ability to transport heavy duty single pallet cargo and delivery of said cargo via a tilting or hinged bed platform. More particularly, a present invention that provides a viable method and apparatus to negate the need for a forklift to load and unload heavy cargo from a trailer.

### BACKGROUND

The classification for tilting or dumping trailers is a broad field that encompasses many registered patents and public domain entries. Trailers that tilt or dump cargo usually have a bed or body portion configured for carrying cargo and for tilting in order to offload, or dump the cargo. Dumping trailers are useful in that they offer a cargo-emptying feature without requiring a dedicated vehicle, such as a dump truck. Further, some dumping trailers eliminate the need for a second vehicle or apparatus to load and unload the cargo from the trailer, such as a forklift or front end loader. A titling trailer can be used as needed by attaching it to a tow vehicle, such as a conventional truck, tractor, sport utility vehicle, automobile, etc. Once the desired cargo has been hauled and delivered using the trailer, the trailer could then be detached from the tow vehicle, leaving the tow vehicle unencumbered and free from its cargo carrier or trailer.

In conventional dump trucks and trailers, the dumping or tilting mechanism is powered by a separate power source, such as a hydraulic or electric lift mechanism. Such mechanisms add weight and expense to the trailer, on top of potential complexity. However, such a power mechanism is oftentimes required due to the weight of the load in the trailer, assuming the load is heavy enough to not allow the trailer to be manually lifted or hinged.

Various types of dump or tilting trailers have been patented. U.S. Pat. No. 2,628,126 discloses trailers of the two-wheel type, that is, the type which is adapted to be supported at the front end by the towing vehicle or tractor. U.S. Pat. No. 4,872,728 discloses a rotating flat-bed trailer which includes a hinge member for pivotally connecting the draw bar or tongue of the trailer to the trailer frame. U.S. Pat. No. 4,494,797 discloses a trailer which includes a frame supported for pivotal movement about the axis of the trailer axle such that the rearward end of the trailer can move toward the ground such that the bed of the trailer is inclined to thereby facilitate loading of a machine onto the trailer. U.S. Pat. No. 5,544,944 discloses a trailer having a right side, left side, opening front and rear end gates, an adjustable length tongue to allow long loads to extend forward of trailer box, a frame that pivots forward of the axle, which allows the trailer box to tilt rearward. U.S. Pat. No. 6,755,479 discloses a trailer which includes a bed that is movable between a generally horizontal, hauling position and a tilted, dumping position. U.S. Pat. No. 5,775,868 discloses a trailer with a wheeled carriage that is mounted on the frame between its front and back ends and includes a pair of walking beam assemblies adapted for pivoting with respect to the frame. U.S. Pat. No. 6,238,166 discloses a utility trailer with selectively deployed chains, which upon backing up the trailer; the tires engage the chains and the trailer moves into the dumping position. And finally, U.S. Pat. No. 4,711,499, U.S. Pat. No. 1,894,320, and U.S. Pat. No. 4,511,181 all disclose titling trailers that pivot at the end of the tow bar. In particular, the registrations disclose the use of tilt locking mechanism and a sliding hinge for dumping rearward of cargo.

The identified registrations, patents, and prior art highlight the desirable feature in a dump trailer to provide a trailer which does not have to be detached from the tow vehicle in order to perform the dumping operation. Additionally, if such dumping could take place without requiring a separate mechanism such as a forklift, such a method would be a further advantage.

The present invention, a Tilt Bed Trailer, draws on many elements of the prior art but is unique and novel in the mechanism, design, and functionality. A current embodiment differentiates itself from the prior art by narrowing the scope of payload or cargo to a one or two pallet load and further by utilizing the inherent gravity pull of the cargo to facilitate delivery and off-loading. The prior art fails to consider these new and novel elements of the present invention, and as such a Tilt Bed Trailer fills a market need with a new and novel invention.

### SUMMARY

A Tilt Bed Trailer is, therefore, directed to an invention that is a single axel with standard two wheel assembly on a heavy duty chassis, rearward hitched, heavy duty trailer constructed in a manner to allow for one or two cargo pallets to be loaded or unloaded from the trailer without needing a forklift, or comparable secondary device. Moreover, the bed of a Tilt Bed Trailer can be elevated by means of a manual, hydraulic, or electric jack that allows the cargo to off-load from the tilted bed of the trailer. A tow vehicle then simply pulls forward leveraging the gravity and weight of the tilted cargo to secure the cargo to the ground while a Tilt Bed Trailer is unloaded simply by pulling forward. Essentially, gravity keeps the cargo in place while a current embodiment of a Tilt Bed Trailer slips out from beneath.

### BRIEF DESCRIPTION OF A TILT BED TRAILER AND FIGURES

Other features and advantages of the present invention or Tilt Bed Trailer will become more apparent from the following detailed description of the embodiments and certain modifications thereof when taken together with the accompanying drawings in which:

FIG. 1 is a perspective side view of a Tilt Bed Trailer in accordance with one example of the current embodiment of the present invention.

FIG. 2 is a perspective view of the functionality of a Tilt Bed Trailer wherein pallet cargo is unloaded from a raised bed position and in accordance with one example of the current embodiment of the present invention.

FIG. 3 is a perspective top view of a Tilt Bed Trailer in accordance with one example of the current embodiment of the present invention.

FIG. 4 is a perspective under-carriage view of a Tilt Bed Trailer that discloses a placement of the tilt fulcrum in accordance with one example of the current embodiment of the present invention.

### DETAILED DESCRIPTION

A function of a Tilt Bed Trailer which will allow for delivery and unloading of one or two pallet bulk cargo without the use of heavy equipment or a forklift.

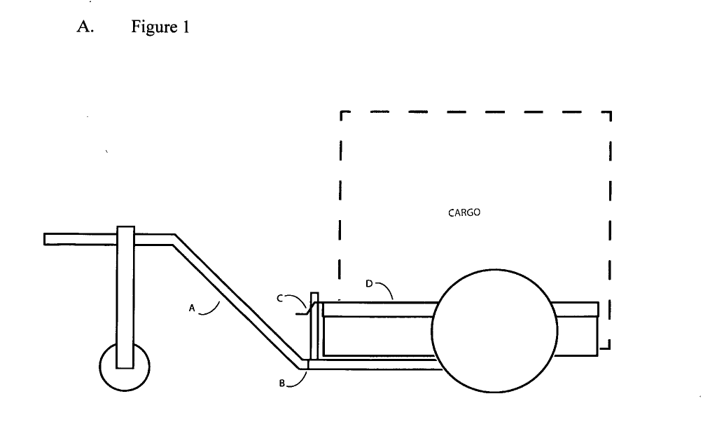

FIG. 1 is a perspective side view of a Tilt Bed Trailer in accordance with one example of the current embodiment of the present invention. The figure illustrates the design and construction of a Tilt Bed Trailer is rearward pull or hitch for a Tilt Bed Trailer. This allows a Tilt Bed Trailer to be hauled by more common vehicles than a gooseneck trailer hitch. A Tilt Bed Trailer is comprised of ¼″ heavy duty tubing, steel or similar compound to serve the needs of support, to ensure it can withstand weight of up to 3500 to 7000 lbs. A standard jack is attached to the tongue of a Tilt Bed Trailer to raise and lower the hitch onto a towing ball.

(A) Depicts how the axel bends proximal to the tongue jack that shall allow the bed of a Tilt Bed Trailer to position the bed approximately four to six inches above the road as one alternative to the current embodiment.

(B) Depicts the point where the tongue can be removed for easy shipping and storage of a Tilt Bed Trailer.

(C) Depicts the heavy duty jack by which the bed of a Tilt Bed Trailer is lifted or titled rearward from the axel. This jack is necessary to unloading a Tilt Bed Trailer as it allows the bed to be raised so that the cargo can simply slip off the trailer.

(D) Depicts the bed of a Tilt Bed Trailer connected to a fulcrum attached at the rear of the axel. The present invention is the only trailer that has a combination of a bed that is low to the ground and a fulcrum that is behind the axel. These two features together allow for the easy unloading of a Tilt Bed Trailer.

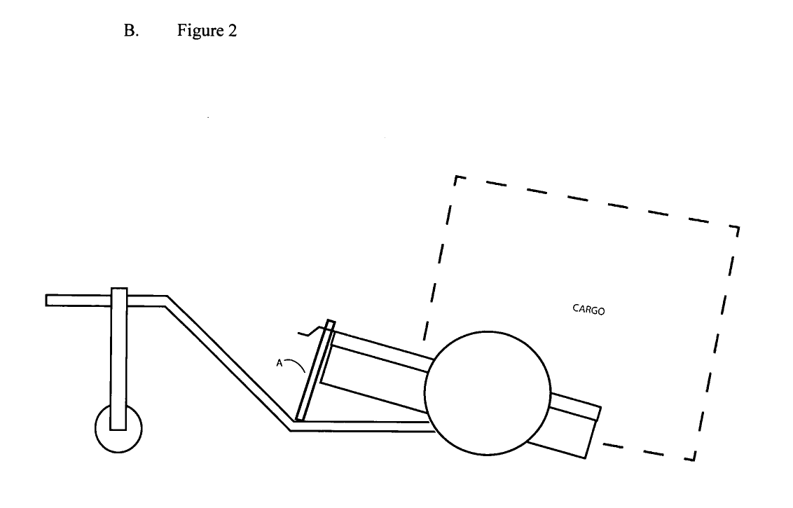

FIG. 2 is a perspective view of the functionality of a Tilt Bed Trailer wherein pallet cargo is unloaded from a raised bed position and in accordance with one example of the current embodiment of the present invention. At the point where the bed of a Tilt Bed Trailer is lifted, as shown in FIG. 2, cargo is unloaded from a Tilt Bed Trailer simply by pulling a Tilt Bed Trailer forward. Gravity and the weight of the cargo keep cargo in place while a Tilt Bed Trailer unloads by moving out from under the cargo. FIG. 2 (A) shows a Tilt Bed Trailer in an elevated position and the cargo in the process of unloading.

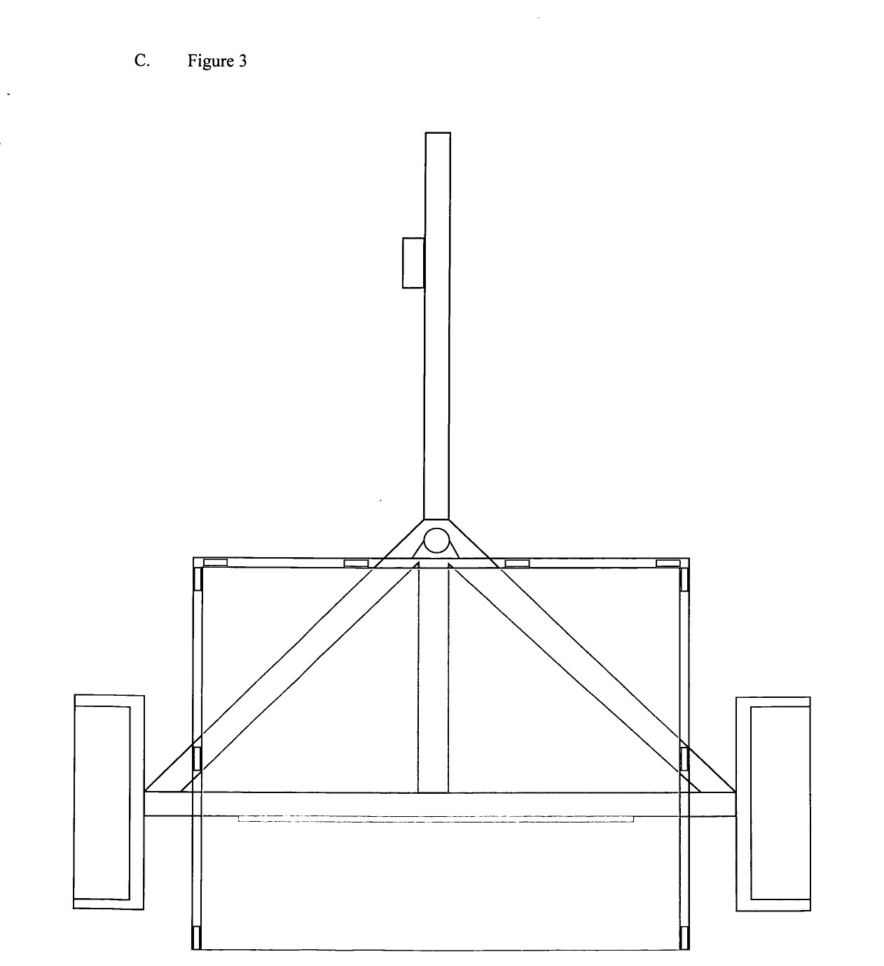

FIG. 3 is a perspective top view of a Tilt Bed Trailer in accordance with one example of the current embodiment of the present invention. The drop axel on a Tilt Bed Trailer is low to the ground to enable convenient loading and unloading cargo, including but not limited to pallet based cargo and containers. The combination of an axel that is low to the ground and a pivoting trailer bed make the Tilt Bed Trailer unique to other trailers. The removable tongue aids in easy storage and shipment of a Tilt Bed Trailer. It also allows the user to increase or decrease the distance from the hitch to a Tilt Bed Trailer.

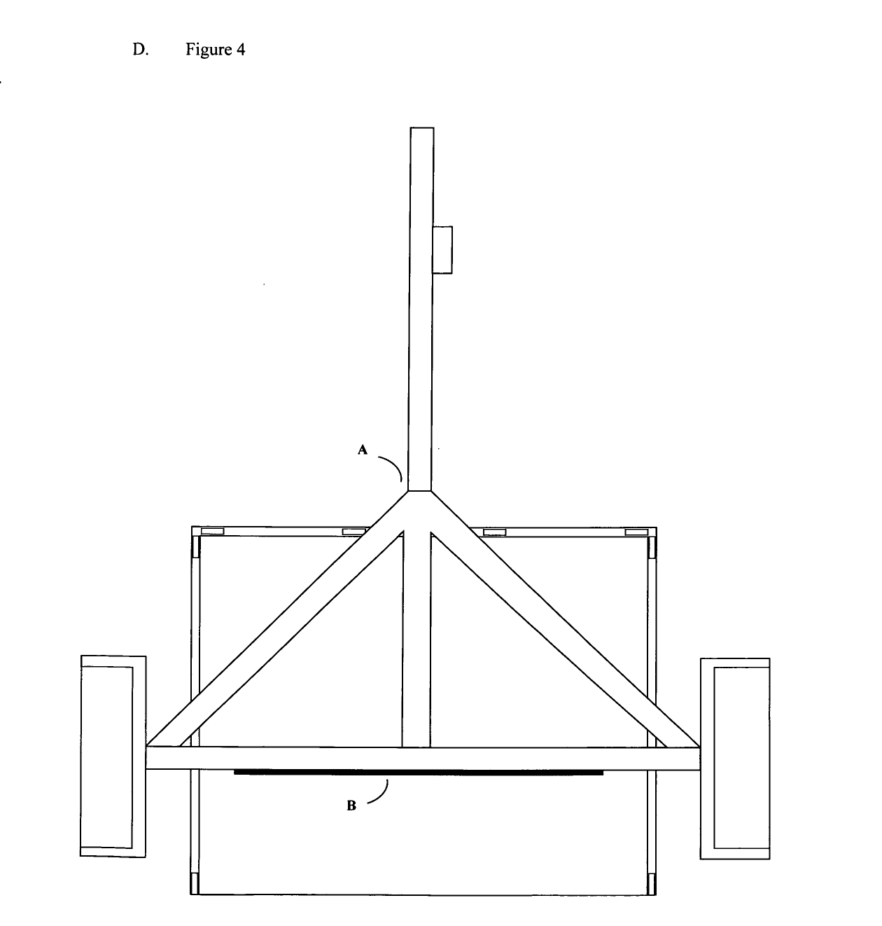

FIG. 4 is a perspective under-carriage view of a Tilt Bed Trailer that discloses a placement of the tilt fulcrum in accordance with one example of the current embodiment of the present invention. The removable tongue enters the frame at point (A) and is secured in a Tilt Bed Trailer by means of a removable pin. The fulcrum of a Tilt Bed Trailer (B) is behind the axel of the trailer (shown in FIGS. 3 and 4) allowing the rear of the cargo to easily reach the ground when the bed is raised.

We claim:

1. A delivery trailer body comprising:
a. A single axel with standard two wheel assembly on a heavy duty chassis;
b. Rearward hitched to a tow vehicle or device;
c. A heavy duty construction to accommodate hauling and delivery of heavy cargo;
d. A single hinged bed or platform for storage, hauling and tilting of cargo;
e. An attached jack with an articulation as a fulcrum behind the trailer axel to allow for a tilt to the cargo bed;
f. Side wall construction to accommodate palleted cargo;
g. Absence of rear wall construction to accommodate pallet cargo that extends farther than the flatbed of the trailer; and
h. Ability to unload heavy cargo without the need for a forklift

2. A delivery trailer of claim 1 further comprising:
a. An axel of approximately four to six inches above the ground for single pallet trailer, but a relatively higher axel articulation for the double pallet version;
b. Removable tongue to aid in shipping and storage;
c. A pivoting trailer bed that tilts rearward by means of a non-specific (manual, hydraulic, electrical, etc.) jack; and
d. A fulcrum attached to the bed of the rear of the axel.
